(19) United States
(12) Patent Application Publication
(10) Pub. No.: US 2012/0017155 A1
(43) Pub. Date: Jan. 19, 2012

(54) Instant delayed gratification presentation-interactive electronic commerce

(76) Inventors: John Lynch, Campbell, CA (US); Michael Ure, Cupertino, CA (US)

(21) Appl. No.: 13/185,393

(22) Filed: Jul. 18, 2011

Related U.S. Application Data
(60) Provisional application No. 61/365,475, filed on Jul. 19, 2010.

(51) Int. Cl. G06F 3/01; G06F 15/16

(52) U.S. Cl. 715/733

(57) ABSTRACT

Interactive electronic commerce capabilities are provided in a way that overcomes prior limitations. In one embodiment, a transaction is performed by: a server system receiving a representation of an audible response of a user to an audio or video program; in response, the server system storing transaction initiation information in a manner accessible to a digital electronic device; wherein a user is enabled to, at a time removed from a time of the audio or video program and in the user's normal course of using the digital electronic device, complete the transaction using the transaction initiation information.

### RELATED APPLICATION

This application claims benefit of U.S. Provisional Application 61/365,475 of the same title, filed 2011 Jul. 19, incorporated herein by reference.

The present invention relates to electronic commerce.

Electronic commerce has become widespread. Presentation-interactive electronic commerce, such as TV-interactive electronic commerce, on the other hand, has been slow to develop. Possible reasons for this slow development include the lack of suitable human interface devices and an insufficient understanding of user-preferred modes of interaction.

As described herein, interactive electronic commerce capabilities are provided in a way that overcomes prior limitations. In one embodiment, a transaction is performed by: a server system receiving a representation of an audible response of a user to an audio or video program; in response, the server system storing transaction initiation information in a manner accessible to a digital electronic device; wherein a user is enabled to, at a time removed from a time of the audio or video program and in the user's normal course of using the digital electronic device, complete the transaction using the transaction initiation information.

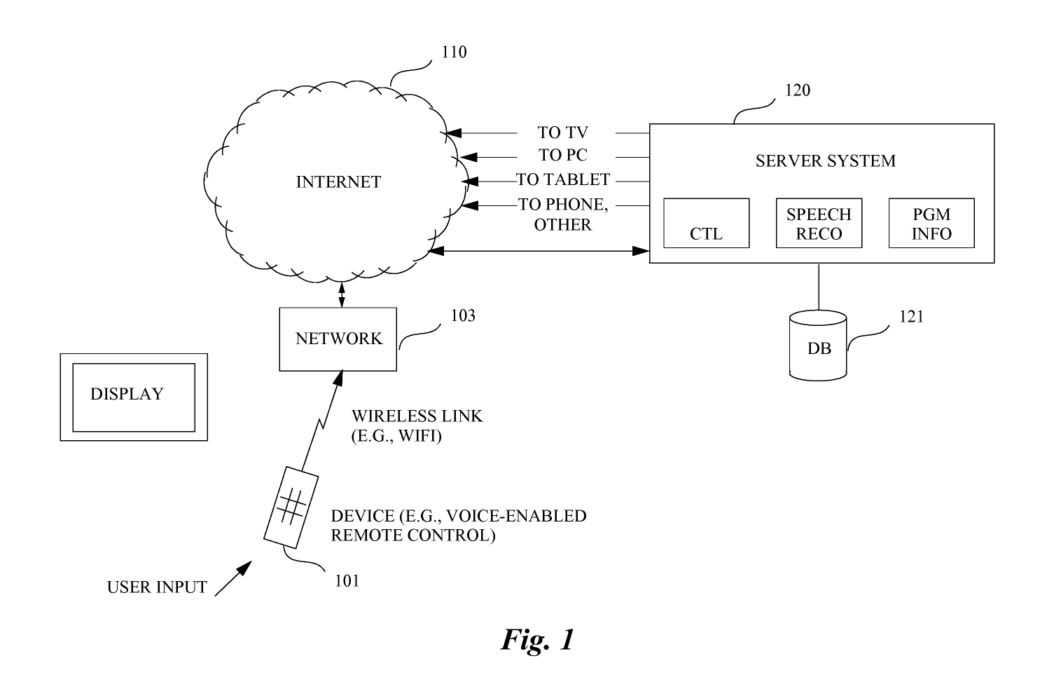

FIG. 1 is a block diagram of an interactive electronic commerce system.

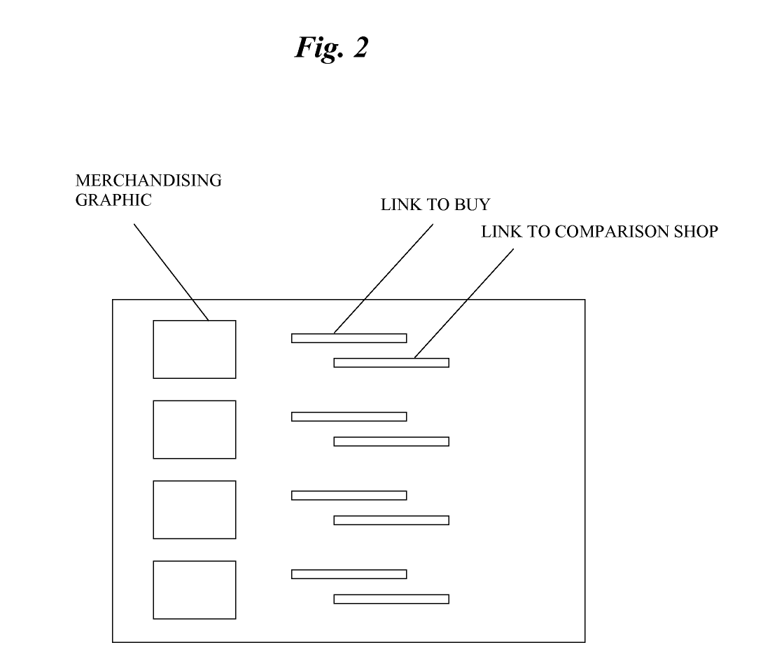

FIG. 2 is a diagram of an example screen that may be used in connection with the system of FIG. 1.

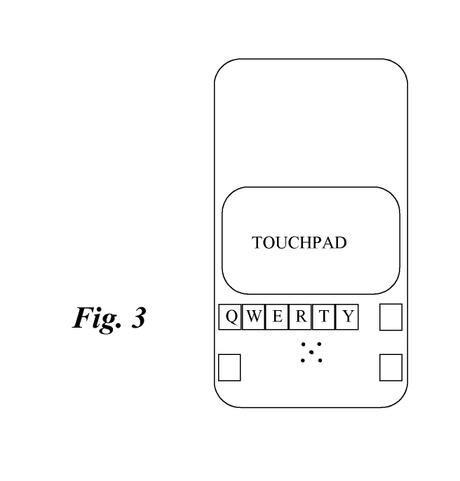

FIG. 3 is a diagram of a reverse side of a remote control unit.

It will be appreciated by those of ordinary skill in the art that the present invention may be embodied in other specific forms than those described below without departing from the spirit or essential character thereof. The following description is therefore intended in all respects to be illustrative and not restrictive. The scope of the invention is indicated by the appended claims, not the following description, and all changes which come within the scope and range of equivalents thereof are intended to be embraced therein.

Referring now to FIG. 1, a diagram is shown of an interactive electronic commerce system. An input device 101 is provided such as a voice-enabled remote control, a cellphone, or other mobile electronic device. The input device 101 communicates wirelessly with a network 103 such as a home network or other network, either directly or indirectly via a TV, a set-top-box, a digibox such as Roku, Boxee, or the like, a TV accessory, etc. During viewing of a presentation or program, a user may make a response, for example an audible response, to the presentation or program. For example, during playing of a song, the user may make an expression of interest in the song. This audible response is transmitted to and received by a server system 120. In one embodiment, the server system 120 performs speech recognition on the audible response in order to ascertain the user's intention. The user's speech input may be constrained or unconstrained.

The server system 120 is also provided with information about what the user was viewing at the time of the audible (or other) response. Any of various mechanisms may be used for this purpose. For example, audio or video information may be captured at the time of the audible response and transmitted to the server system together with or in correspondence with the audible response. Explicit program and program time information may be transmitted to the server system together with or in correspondence with the audible response. Closed-caption information may be captured and transmitted to the server system together with or in correspondence with the audible response. A simple timestamp may be transmitted to the server system together with or in correspondence with the audible response, to be correlated with separate information concerning the program being viewed at the time of the audible response. In accordance with another alternative, presentation metadata may be transmitted via a short-range wireless link and captured at the time of the user response. Other mechanisms whereby the server system may be informed what was being presented at the time of the audible response will be apparent to those skilled in the art.

Using such information, in one embodiment, the server 120 queries a database 121 that stores program metadata descriptive of people, places, things, works, etc., occurring at various times throughout the program. The metadata may reveal, for example, that at the time of the audible response, the program was playing Song X by Artist Y. Furthermore, the audible response may have been recognized to be “iTunes.”

The database 121 may, for example, be an XML-based database, or a database of any of a variety of suitable forms. Logically, within the database 121 the program may be divided into scenes with beginning and ending scene times, each scene having associated with it an XML data structure that identifies people, places, things, works, etc., occurring during that scene, together with any other information that may be helpful in making that program scene actionable, for example information about how to purchase a product or work. The database 121 may be made accessible to interested parties and may be populated cooperatively by those interested parties in a wiki-like manner.

Scenes may be identified automatically using audio and/or video information, existing database resources, etc. In one embodiment, a scene must first be named by an interested party before other information may be populated. A scene may have many different names. In one embodiment, in response to a scene name, the scene is played back to an interested party, enabling positive identification of the scene prior to the interested party populating information concerning the scene. Beyond just interested parties, view-by-scene may be made available to the public at large, with scenes being ranked by popularity.

From the description thus far, it will be appreciated that the prior lack of suitable human interface devices is overcome using, for example, voice interactivity in a convenient and intuitive manner.

There remains choosing a mode of interaction that will be favored by users. In the present embodiment, “in-program” or “time-of-presentation” interaction may be limited simply to the capture and transmission of the audible or other response of the user and possible acknowledgment of the same, audibly, visually, or both. The user obtains “instant gratification” from the ability to readily act upon perceived opportunities for satisfaction. Rather than interrupt the user's enjoyment of the program or presentation with purchase details or other details, however, ultimate gratification may be delayed and carried out at a later time in the normal course of the user's digital life, as presently described. The phrase “instant delayed gratification” is used herein to describe this advantageous mode of user interaction.

Preferably, program code is provided on at least four different platforms to enable completion of transactions including purchase transactions: the TV, the PC, the tablet and the mobile phone (e.g., smartphone). As illustrated in FIG. 1, the server system 120 communicates with these connected devices through the internet 110, in either wired or wireless fashion. At least two different modes of completion are provided for: explicit and implicit.

In the case of explicit completion, program code such as an app, widget or the like is provided, a principal purpose of which is explicit transaction completion. The program code may be installed during setup of the TV, set-top box, TV accessory, PC, tablet, smartphone, etc. An icon associated with the program code may have a state indicator that calls the user's attention to the program code and indicates, for example, how many transactions are awaiting completion. When the user clicks on the icon, the transactions are displayed, either in a single list or grouped by category, each transaction with a description of the subject of the transaction and preferably also with a thumbnail graphic associated with the transaction as illustrated in FIG. 2, for example. By clicking on the link, a helper application such as iTunes or the like will be launched in order to complete the transaction. The link will typically have embedded in it a referrer code to enable the technology provider to be compensated as part of the transaction. If desired, a “comparison shop” link may also be provided, allowing the user to comparison shop for the goods or services in question.

In the case of implicit completion, program code operates in the background and waits for a desired helper app (e.g., iTunes) to be launched on the same platform. The program code then at the appropriate time sends a link to the helper app to initiate transaction completion. In some instances, the program code may in fact abort the first launch of the helper app and trigger a subsequent launch by means of the link. In other instances, the first launch of the helper app is allowed to complete and the program code operates within the context of the first launch to initiate completion of the transaction.

The transaction system may receive other types of user input instead of or in addition to voice input, including, for example, gestures, touch, keystrokes or button presses, point-and-click, etc. Referring to FIG. 3, in some embodiments, a reverse side of the device 101 may be provided with a QWERTY keypad and/or a touchpad. The touchpad may be single-touch or multi-touch. The front side of the remote control may be provided with a layout of buttons (volume, channel, etc.) so as to provide the user a familiar experience. If the input device 101 is a PC, tablet, smartphone, etc., user input may be accomplished in any of the usual ways when using such devices.

The transaction system may be used with audio or video content played by any of a variety of presentation devices, including TVs, PCs, mobile electronic devices, smartphones, tablets, kiosks, etc. In the case of kiosks, such as bank kiosks (ATMs), gas stations kiosks (pumps), etc., a short-range wireless link, such as a Bluetooth link, for example, or image capture, may be used to communicate information concerning the presentation to the server system 120 via a user device (e.g., smartphone, tablet, etc.).

Moreover, the transaction system may be used not only in connection with audio or video content but also in connection with printed visual content, still-image content and the like. Interaction with such content may be achieved through any of various means, including, for example, short-range wireless links (e.g., Bluetooth, NFC, RFID, etc.), image capture (e.g., barcodes, QR codes, whole image capture), etc. For example, at an arena, promotional materials may be posted along the walls of the arena. A user interested in the promotion may swipe or tap an area of the promotion using a mobile electronic device, or may perform image capture of part or all of the promotion. An application on the mobile electronic device is programmed to input information received as a result of the swipe, tap, image capture operation, etc., and to send such information to the server system 120. The server system 120 is programmed to interpret the received information and to communicate transaction initiation information to the TV, PC, tablet, smartphone or other mobile electronic device, etc., in the manner previously described.

The scope of the invention is indicated by the appended claims, not the foregoing description, and all changes which come within the scope and range of equivalents thereof are intended to be embraced therein.

What is claimed is:

1. A transaction method comprising:
a server system receiving a representation of a response of a user to a presentation;
in response, the server system storing transaction initiation information in a manner accessible to at least one digital electronic device;
wherein a user is enabled to, at a subsequent time, complete the transaction using the transaction initiation information.

2. The method of claim 1, wherein the server system stores transaction initiation information in a manner accessible to multiple different digital electronic devices of the user.

3. The method of claim 1, wherein the response is an audible response.

4. A transaction system comprising:
a server system receiving a representation of a response of a user to a presentation, the server system being configured to, in response, store transaction initiation information in a manner accessible to a digital electronic device;
wherein a user is enabled to, at a subsequent time, complete the transaction using the transaction initiation information.

5. The system of claim 4, wherein the response is an audible response.

6. The method of claim 1, wherein the presentation is one of the following: an audio presentation, a video presentation, and a still-image presentation.

7. The apparatus of claim 4, wherein the presentation is one of the following: an audio presentation, a video presentation, and a still-image presentation.
